(19) United States
(12) Patent Application Publication
(10) Pub. No.: US 2019/0174784 A1
(43) Pub. Date: Jun. 13, 2019

(54) NEW METHOD TO MANUFACTURE FERMENTED SET-STYLE MILK-BASED PRODUCT

(71) Applicant: DUPONT NUTRITION BIOSCIENCES APS, Copenhagen K (DK)

(72) Inventors: Enrique Guillermo D'Argence Vargas, Mexico City (MX); Hans Christian Bejder, Horsholm (DK)

(21) Appl. No.: 16/326,842

(22) PCT Filed: Aug. 21, 2017
(86) PCT No.: PCT/EP2017/071026

§ 371 Date: Feb. 20, 2019

(30) Foreign Application Priority Data
Aug. 22, 2016 (EP) 16185183.7

(51) Int. Cl. A23C 9/123

(52) U.S. Cl. CPC A23C 9/1238; A23Y 2240/75; A23Y 2220/15

(57) ABSTRACT

The invention is directed to a method to manufacture a fermented set-style milk-based product, such as a set-style yogurt, comprising an interruption step during fermentation. In a particular embodiment, the interruption of the fermentation is carried out by cooling the partially fermented milk-based substrate to a temperature comprised between 2 and 10° C. The invention is also directed to a partially fermented milk-based substrate as such or in a container.

### FIELD OF THE INVENTION

The invention is directed to a method to manufacture a fermented set-style milk-based product, such as a set-style yogurt, comprising an interruption step during fermentation. In a particular embodiment, the interruption of the fermentation is carried out by cooling the partially fermented milk-based substrate to a temperature comprised between 2 and 10° C. The invention is also directed to the partially fermented milk-based substrate as such or in a container.

### BACKGROUND OF THE INVENTION

Nowadays, there are two main processes to produce yogurt. The conventional method used to manufacture stirred yoghurt is based on the incubation of the inoculated milk in tanks and then cooling before packing (FIG. 1). Briefly, the starter culture is inoculated into the milk, and the inoculated milk is then incubated in a tank to about 42-43° C. between 3 to 6 hours until the required pH (normally about 4.2-4.5) has been reached; then the yogurt is cooled to 15-22° C. and the cooled yogurt is transferred by pumping into the packages (or alternatively the cooled yoghurt is pumped to buffer tanks before being routed to the filling machine). The conventional method used to manufacture set yoghurt is based on the incubation of the inoculated milk and cooling in the food packages (FIG. 2). Briefly, the starter culture is inoculated into the milk. The inoculated milk is then transferred into the food packages, where it is incubated to about 42-43° C. between 3 to 6 hours in confined incubation room. When the required pH (typically 4.5) is reached, the yogurt is cooled to about 18-20° C. However, this process lacks flexibility, since there is a need to match pre-treatment capacity to packing capacity. Therefore, alternatively, the milk can be cooled to less than 10° C., and pumped into one or more tanks. Following inoculation and thorough stirring, the milk is thus ready to be heated in-line to incubation temperature, before being packed in food packages.

In some countries, the actual methods to manufacture yoghurt, in particular set-yogurt, are not satisfactory in terms of capacity and flexibility. As an example, in the countries of the Middle-East, especially during the Ramadan season, there is a need to substantially increase capacity as demand peaks. However, none of the 2 processes detailed above is flexible enough for significantly increasing production capacity. For set-style yogurt, increasing capacity can only be done by shortening the time of the fermentation, since the fermentation is entirely done in food packages in an incubation room, i.e., a confined temperature-controlled room in the factory. Indeed, it is simply not possible in a conventional set-style yoghurt process to expand or reduce the confined temperature-controlled room proportionally to productivity requirements in a flexible manner.

Therefore, there is a need to improve the manufacturing process of fermented set-style milk-based products, to increase production capacity at acceptable costs, while not compromising on the quality of the fermented set-style milk-based products.

### DESCRIPTION OF THE FIGURES

FIG. 1: stirred-style yogurt

FIG. 2: set-style yogurt

FIG. 3: an embodiment of the invention

FIG. 4: an embodiment of the invention

FIG. 5: Force (g) plotted against time (s); depicting a typical back extrusion test for set yogurts.

FIG. 6: Textural properties of yogurts fermented with Yo-Mix® 810 at 43° C. to pH 4.6 with an interruption step at different pH values in comparison to an uninterrupted control sample. Measured after 5 days (A: Firmness, B: Consistency, C: Adhesiveness, D: Viscosity)

FIG. 7: Textural properties of yogurts fermented with different starter cultures to pH 4.6 with an interruption at pH 5.8 (light grey) in comparison to a control (uninterrupted control sample—dark grey) (A: Firmness, B: Consistency, C: Adhesiveness, D: Viscosity), at 14 days.

FIG. 8: Textural properties of yogurts fermented with different starter cultures to pH 4.6 with an interruption at pH 5.8 (light grey) in comparison to a control (uninterrupted control sample—dark grey) (A: Firmness, B: Consistency, C: Adhesiveness, D: Viscosity), at 28 days.

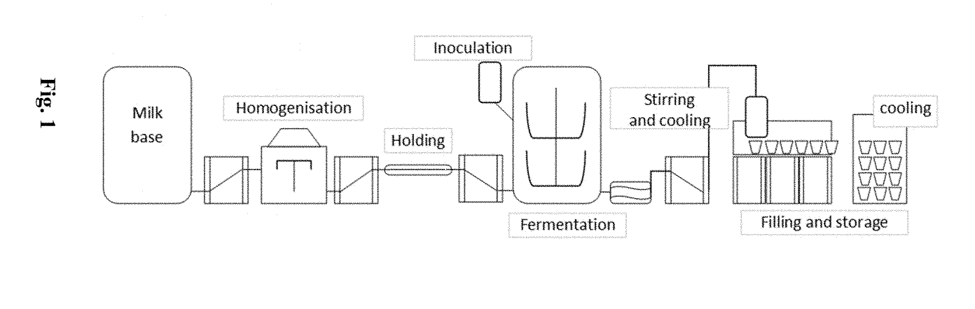

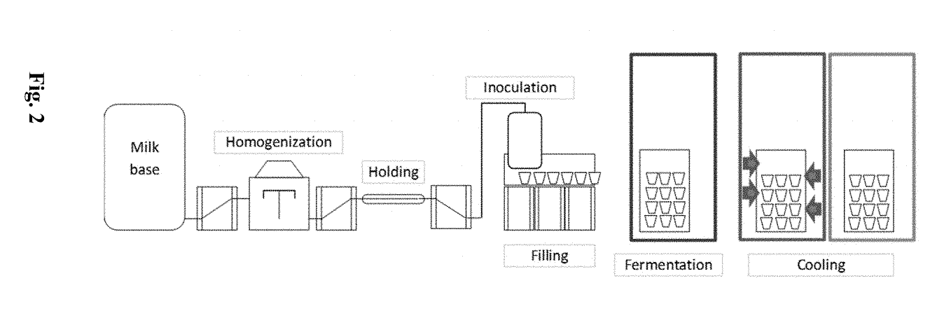

### DESCRIPTION OF THE INVENTION

The inventors have shown that it is possible to interrupt the fermentation during set-style milk-based product manufacturing, at a particular pH range and up to 24 hours, while keeping the quality of the final fermented set-style milk-based product. Thus, it is possible to stop the fermentation for a desired period of time, and to start again the fermentation in order to have a final product when desired. Surprisingly, the inventors have shown that this interruption step not only enables to decrease the time of fermentation carried out in the food packages (incubation room) but also has no impact on the quality of the final product.

Trejo et al. (2014), with the aim of developing methods allowing the manufacture of firm fat-free yogurt exhibiting high whey holding capacity (resistance to syneresis) and solid-like gel behavior, reported the introduction of a cold step (4° C.) at pH 5.2 (from 30 to 120 minutes) during yoghurt manufacturing. In addition to study the effect of the cold step on the whey holding capacity, Trejo et al. also studied effect of the cold step on the rheological properties of the obtained yogurt after 2 days of storage. The authors concluded that the pumping of partially fermented yoghurt has no negative effect on the final product as compared with yogurt set in the original containers.

In contrast to Trejo et al., the inventors have shown that introducing an interruption step at pH 5.2 during the manufacture of set yoghurt has a significant impact on all the tested quality characteristics (firmness, consistency, adhesiveness and viscosity) at 5, 14 or 28 days of storage (see example 1). Considering that yogurt texture is an important quality attribute for the overall acceptability by the consumer, the teaching of Trejo et al. is not applicable to the manufacture of fermented set milk based products.

Therefore, there is a need to develop a new flexible process to manufacture fermented set milk-based products with acceptable rheological properties.

Thus, the present invention is directed to a method to manufacture a fermented set-style milk-based product comprising or consisting:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2;
c) to transfer said partially fermented dairy substrate of step b) into one or more second container(s); and
d) to incubate said partially fermented substrate in said one or more second container(s), to restart the lactic acid fermentation until the pH reaches a range between 3.5 and 5, to obtain a fermented set-style milk-based product;
wherein the method comprises a step, after step b) and before step d), where the lactic acid fermentation of said partially fermented substrate is stopped, for a period between 5 minutes and 24 hours, while maintaining the concentration of viable lactic acid bacteria stable.

The term “set-style product” has the definition commonly used in fermented dairy manufacturing. Thus, and in accordance with the common definition, the expression “set-style product” means a product which has been inoculated with a starter culture, has been fermented until the desired final pH [formation of a coagulum] and then has been cooled, but has not undergone mechanical treatment after fermentation and/or cooling. Examples of mechanical treatment are typically, but not exclusively, stirring, pumping, filtrating or homogenizing the coagulum, or by mixing it with other ingredients. Thus, a set style product has an unbroken gel structure. Set style products are not liquid. In contrast, “stirred type product” (which are not concerned by the present invention) refers to a product which sustains a mechanical treatment after inoculation, fermentation and cooling, resulting in a destructuration and liquefaction of the coagulum formed under the fermentation stage. A stirred type product has the texture of a viscous fluid.

The term “fermented” means that the milk-base substrate, in particular the milk substrate, has undergone a decrease of its initial pH to the desired final pH, following the production of lactic acid (preferably by conversion of lactose) through the action of microorganism(s), in particular lactic acid bacteria. Thus, according to the invention, the final pH of the fermented set-style milk-based product is comprised between 3.5 and 5, whereas the initial pH of milk-based substrate, in particular milk substrate, is typically between 6.6 and 6.8. The expression “a pH between 3.5 and 5” encompasses particular embodiments, wherein the pH of the fermented substrate is comprised between 4 and 5, in particular between 4.2 and 4.8. In a particular embodiment, the pH of the fermented substrate at the end of step d) has a value selected from the group consisting of 4.4±0.2, 4.4±0.3, 4.4±0.4, 4.4±0.5 and 4.4±0.6.

In a particular embodiment of the invention, the set-style milk-based product is a set-style yoghurt. The term “yogurt” is defined according to French and European regulations, i.e., coagulated dairy products obtained by lactic acid fermentation with specific thermophilic lactic acid bacteria (i.e. Lactobacillus delbruekii subsp. bulgaricus and Streptococcus thermophilus).

In step a) of the method of the invention, a milk-based substrate inoculated with a lactic acid bacteria starter culture is provided in a first container.

The expression “milk-based substrate” means either milk substrate or a mixture of milk substrate and soy. In a particular embodiment of the invention, the milk-based substrate is milk substrate. By “milk”, it is meant milk from a mammal source. Mammal sources of milk include, but are not limited to, cow, sheep, goat, buffalo, camel, llama, mare and deer. Thus, the milk substrate is milk selected from the group consisting of cow, sheep, goat, buffalo, camel, llama, mare and deer, and any combinations thereof. In a particular embodiment of the invention, the milk substrate is of cow origin. The expression “milk-based substrate” or “milk substrate” encompasses raw and/or processed milk material that can be subjected to fermentation according to the method of the invention. Thus, useful milk substrates include, but are not limited to, solutions/suspensions of any milk or milk like products comprising protein, such as but not limited to whole or low fat milk, skim milk, reconstituted milk powder, condensed milk, dried milk, whey or whey permeate. The milk-based substrate, in particular the milk substrate, provided in step a) is typically previously treated, in particular by standardization, addition of additives [e.g., sugar, sweeteners and/or stabilisers], homogenization and/or heat-treatment [e.g., pasteurization]. In a particular embodiment, when the milk-based substrate is a mixture of milk substrate and soy, the soy part is selected from the group consisting of a soy extract, a soy protein concentrate or a soy isolate.

Thus, the milk-based substrate, in particular the milk substrate, provided in step a) is inoculated with lactic acid bacteria starter culture. The term “inoculating” means that the lactic acid bacteria are added into the milk-based substrate, in particular into the milk substrate, such that the lactic acid bacteria are able to be metabolically active and produce lactic acid when incubated.

The expression “starter culture” means a composition comprising or consisting of one or more lactic acid bacteria, which are responsible for the acidification of the milk-based substrate, in particular of the milk substrate. The expression lactic acid bacteria (LAB) relates to food-grade bacteria producing lactic acid as the major metabolic end-product of carbohydrate fermentation, and are in the present invention for the acidification of milk, the formation of the milk coagulum and the texture of the fermented product. Typically, any lactic acid bacteria can be used herein as long as they are suitable to ferment milk-based substrate. In a particular embodiment, the lactic acid bacterium or bacteria of the starter culture is/are from a genus selected from the group consisting of Lactobacilli, Streptococci, Bifidobacterium, Lactococci and any mixture thereof. In a particular embodiment of the invention, the lactic acid bacterium or bacteria of the starter culture is/are selected from the group consisting of Lactobacillus spp., Bifidobacterium spp., Streptococcus spp., Lactococcus spp or any mixture thereof. In a particular embodiment, the lactic acid bacterium or bacteria of the starter culture is/are selected from the group consisting of Streptococcus thermophilus, Lactobacillus delbrueckii subsp. bulgaricus, Bifidobacterium animalis, Bifidobacterium breve, Lactobacillus acidophilus, Lactobacillus casei, Lactobacillus plantarum, Lactobacillus helveticus, Lactococcus lactis and any mixture of 2, 3 or 4 of these strains. In a particular embodiment, the lactic acid starter culture comprises or consists of—as microorganism—Streptococcus thermophilus. In a particular embodiment, the lactic acid starter culture comprises or consists of as microorganisms—Streptococcus thermophilus and Lactobacillus delbrueckii subsp. bulgaricus.

Starter cultures can be inoculated into the milk-based substrate under any form, such as under frozen, dried, freeze-dried, liquid or solid format, in the form of pellets or frozen pellets, or in the form of a powder or dried powder. In a particular embodiment of the invention, the milk-based substrate is inoculated with a starter culture under liquid form, for example as bulk starter [i.e., a culture previously propagated in a growth medium to obtain the required concentration of inoculation]. In a particular embodiment of the invention, the milk-based substrate is directly inoculated with a starter culture under the form of concentrates, for example frozen or dried concentrates. In a particular embodiment of the invention, the milk-based substrate is directly inoculated with a starter culture under liquid form as a dilution [e.g. in water or saline solution] of concentrates, such as of frozen or dried concentrates. The expression “directly inoculated” means that the starter culture is inoculated into the milk-based substrate without previous propagation. The direct inoculation requires that the concentration of the starter culture be high enough. Thus, in a particular embodiment of the invention, the concentration of LAB in the frozen or dried concentrate as defined herein is in the range of 10⁸ to 10¹² cfu per g of concentrate, and more preferably at least 10⁸, at least 10⁹, at least 10¹⁰, at least 10¹¹ or at least 10¹² cfu/g of concentrate.

Whatever the form of the LAB starter culture, the milk-based substrate is inoculated with a concentration of at least 10⁵ cfu of lactic acid bacteria per g of milk-based substrate. In a particular embodiment, said milk-based substrate is inoculated at a concentration of at least 10⁶, at least 10⁷ or at least 10⁸ cfu of lactic acid bacteria per g of milk-based substrate. In a particular embodiment, said milk-based substrate is inoculated at a concentration between 10⁵ to 10⁸ cfu of lactic acid bacteria per g of milk-based substrate.

Any concentration expressed in “10^{x} cfu/g” within this application is to be understood as 10^{x}±a half log of 10^{x} cfu/g (for example 10⁵ cfu/g means 10⁵±a half log of 10⁵, i.e. between 5.10⁴ and 5.10⁵ cfu/g).

The expression “first container” means herein a container the purpose of which is for, or a container suitable for, receiving a milk-based substrate inoculated with a starter culture and incubating said milk-based substrate to start the fermentation of said milk-based substrate. In a particular embodiment, the volume of said first container is at least 500 litres, at least 1000 litres, at least 2000 litres, at least 5000 litres, at least 10000 litres, at least 20000 litres or at least 30000 litres. In a particular embodiment, optionally in combination with the previous one, the first container is a process tank, i.e., a tank made of steel, optionally with some form of agitator and/or temperature control. In contrast to the second container defined below, said first container is not a food package (in particular is not a pot, cup or beaker). In a particular embodiment, when the application refers to a milk-based substrate in a first container (method of the invention) or a partially fermented milk-based substrate in a first container (as such), it is meant that at least 50% of the volume of said first container (as defined above) is filled with said milk-based substrate or with said partially fermented milk-based substrate (the remaining of the container being not filled). In a particular embodiment, at least 60% of the volume of said first container is filled with said milk-based substrate or with said partially fermented milk-based substrate. In a particular embodiment, at least 70% of the volume of said first container is filled with said milk-based substrate or with said partially fermented milk-based substrate. In a particular embodiment, at least 80% of the volume of said first container is filled with said milk-based substrate or with said partially fermented milk-based substrate. In a particular embodiment, at least 90% of the volume of said first container is filled with said milk-based substrate or with said partially fermented milk-based substrate. In a particular embodiment, at least 95% of the volume of said first container is filled with said milk-based substrate or with said partially fermented milk-based substrate.

In step b) of the method of the invention, said inoculated substrate is incubated under conditions to start the lactic acid fermentation and to obtain a partially fermented substrate with a pH comprised between 5.4 and 6.2.

The incubation in step b) is carried out in the first container under appropriate conditions for the lactic acid bacteria of the starter culture to produce lactic acid and start the fermentation of the milk-based substrate. Incubation conditions to be used in fermentation of milk-based substrate, in particular in fermentation of milk substrate, are well known and the person skilled in the art will know how to select suitable incubation conditions, such as temperature, oxygen, optional addition of carbohydrates and incubation time. Obviously, incubation conditions in step b) are selected so as to obtain a partially fermented substrate with a pH comprised between 5.4 and 6.2. In a particular embodiment, the incubation temperature is between 20 and 50° C., and in particular between 20 to 35° C. for mesophilic strains or between 35 to 50° C. for thermophilic strains. In a particular embodiment, when a lactic acid bacteria starter culture comprising or consisting of Streptococcus thermophilus and optionally Lactobacillus delbrueckii subsp. bulgaricus is used, the incubation temperature is between 30 to 50° C., more particularly between 35 and 46° C. The incubation of step b) is terminated when the desired pH is reached, i.e., when the pH of the milk-based substrate, in particular the milk substrate, decreases to a value between 5.4 and 6.2 (“partially fermented substrate”). The time of incubation in step b) is typically between 1 and 3 hours, depending for example on the format of the used LAB starter culture.

The expression “a pH between 5.4 and 6.2” encompasses particular embodiments, wherein the pH of the partially fermented substrate at the end of step b) is comprised between 5.6 and 6.2, between 5.6 and 6.0, between 5.8 and 6.0 and between 5.6 and 5.8. In a particular embodiment, the pH of the partially fermented substrate at the end of step b) has a value selected from the group consisting of 5.5±0.1, 5.6±0.1, 5.7±0.1, 5.8±0.1, 5.9±0.1, 6.0±0.1 and 6.1±0.1.

It is an essential and inventive step of the invention that the method of the invention comprises, after step b) and before step d), a step where the lactic acid fermentation of said partially fermented substrate (obtained at the end of step b) is stopped, for a period between 5 minutes and 24 hours, while maintaining the concentration of viable lactic acid bacteria stable [interruption step]. Thus, the fermentation of the partially fermented substrate is stopped (or interrupted) for a period of time ranging from 5 minutes to 24 hours (between 5 minutes and 24 hours), and in particular for a period of time ranging from a minimal time selected from the group consisting of 10 minutes, 20 minutes, 30 minutes, 1 hour, 2 hours and 3 hours to a maximal time selected from the group consisting of 5 hours, 10 hours, 15 hours and 20 hours. By “stopped”, it is meant that the pH of the partially fermented substrate stays in the range 5.4 and 6.2 between the beginning and the end of the interruption step, as a consequence of the absence of production of lactic acid by the bacteria of the starter culture. In a particular embodiment, the pH of the partially fermented substrate between the beginning and the end of the interruption step does not vary more than 0.3, in particular not more than 0.2 and more particularly not more than 0.1 (while still staying in the range between 5.4 and 6.2).

The interruption of the lactic acid fermentation of the partially fermented substrate, after step b) and before step d), can be done at two different stages of the method of the invention, i.e., either before or after the transfer step into the one or more second containers (step c). Thus, in a first embodiment, the fermentation is stopped after the end of step b) [when the partially fermented substrate as defined herein has been obtained] and before step c) [transfer of the partially fermented substrate into the second container(s)]. In another embodiment of the invention, the fermentation is stopped after step c) [transfer of the partially fermented substrate into the second container(s)] and before step d) [incubation of said partially fermented substrate in said one or more second container(s)]. Whatever the embodiment, the interruption of the fermentation of the partially fermented substrate is carried out by any means, such that the concentration of viable lactic acid bacteria of the starter culture present in the partially fermented substrate is maintained stable during the interruption step (i.e., between the beginning and the end of the interruption step).

By “stable”, it is meant that the concentration of viable lactic acid bacteria of the starter culture (in cfu by g or by ml of partially fermented substrate) does not vary more than half a log during the interruption step (meaning that the concentration at the end of the interruption step is not more than ±half a log the concentration before the interruption step).

In a particular embodiment, the interruption step consists of bringing the partially fermented substrate as defined herein to a positive temperature which is below the incubation temperature for the period of time described herein, while the concentration of viable lactic acid bacteria of the starter culture present in the partially fermented substrate is maintained stable during the interruption step. In a particular embodiment, the partially fermented substrate as defined herein is brought to a temperature comprised between 2 and 10° C. In a more particular embodiment, the partially fermented substrate as defined herein is brought to a temperature comprised between 4 and 6° C. Production of lactic acid is directly related to the incubation temperature; therefore, to drop the temperature of the partially fermented substrate to a temperature comprised between 2 and 10° C. stops the production of lactic acid.

In a particular embodiment, the interruption step consists of decreasing the temperature of the partially fermented substrate from the incubation temperature to a temperature comprised between 2 and 10° C., holding the temperature of the partially fermented substrate between 2 and 10° C. and increasing the temperature of the partially fermented substrate to the incubation temperature, where the interruption step lasts for the period of time described herein. In a particular embodiment, when an intermediary container is used, the decrease of the temperature is carried out during the transfer of the partially fermented substrate from the first container into the intermediary container (step b2) and the increase of the temperature is carried out during the transfer of the partially fermented substrate from the intermediary container into the one or more second containers (step c). Means to cool and to heat substrate are well known in the art, such as conventional heat exchangers, for example plate heat exchanger.

In a particular embodiment, the pH of the partially fermented substrate at the end of step b) and during the interruption step is comprised and maintained in a range from 5.6 to 6.0.

In step c) of the method of the invention, the partially fermented dairy substrate obtained in step b) is transferred into one or more second container(s). The expression “obtained in step b)” includes “obtained in step b2)” according to the embodiment of the invention. The expression “second container” means a food package, i.e., a container which is suitable for or adapted to food packaging and distribution and optionally for protection of the product and preservation of its food value. In a particular embodiment, said one or more second containers is a container made of plastic, glass, paperboard, carton, polystyrene or any combination thereof. In a particular embodiment, optionally in combination with the previous one, the maximal volume of said one or more second container is selected from the group consisting of 5 litres, 2 litres, 1 litre, 800 ml, 500 ml, 400 ml, 300 ml, 200 ml, 150 ml, 120 ml and 100 ml. In a particular embodiment and in addition to any embodiments regarding second container defined herein (including the maximal volume), said one or more second containers is adapted to be sealed with a membrane. In a particular embodiment, said one or more second containers is a container especially adapted to set fermented dairy products, such as a yogurt pot, yogurt cup or yogurt beaker.

In a particular embodiment, the volume of the first container is at least 1000 litres and the volume of the one or more second container(s) is at most 5 litres.

In a particular embodiment, in step c), the partially fermented dairy substrate obtained in step b) is transferred into at least 2 second container(s). As a particular embodiment, said at least 2 second containers (in addition to the possible embodiments defined above regarding the expression “second container”), are arranged in a row or rows of several containers (for example row(s) of 2, 4, 6 or 8 second containers) connected to one another along their flanges. Thus, in a particular embodiment, in step c), the partially fermented dairy substrate obtained in step b) is transferred into a pack comprising at least one row of separable second containers (see FR2432975 or WO2012123775).

The expression “transferred” in step c) means that the one or more second containers is (are) filled with the partially fermented milk-based substrate. In a particular embodiment, the one or more second containers is (are) filled with the partially fermented milk-based substrate obtained at the end of step b). In another particular embodiment, the one or more second containers is (are) filled with the partially fermented milk-based substrate after the end of the interruption step described above.

In a particular embodiment, the method of the invention comprises a direct transfer from the first container to the one or more second containers [i.e., without transfer into intermediary container(s)].

In another embodiment, the method of the invention comprises an indirect transfer from the first container to the one or more second containers, i.e., the partially fermented milk-based substrate obtained at the end of step b) is transferred into intermediary container(s), where the fermentation of the partially fermented milk-based substrate obtained at the end of step b) is stopped as described herein. Later on, the partially fermented milk-based substrate is then transferred into one or more second containers [step c]. The intermediary container is not a second container as defined herein. There is no fermentation or incubation in the intermediary container. The intermediary container (also called storage or buffer tank) is typically made of steel and insulated to maintain a constant temperature to the partially fermented milk-based substrate, and may optionally comprises some form of agitator and/or temperature control. In a particular embodiment, the volume of an intermediary control is at least 500 litres, at least 1000 litres, at least 2000 litres, at least 5000 litres, at least 10000 litres, at least 20000 litres or at least 30000 liters. In a particular embodiment, when the application refers to a partially fermented milk-based substrate in an intermediary container (method of the invention or as such), it is meant that at least 50% of the volume of said intermediary container (as defined above) is filled with said milk-based substrate or with said partially fermented milk-based substrate (the remaining of the intermediary container being not filled). In a particular embodiment, at least 60% of the volume of said intermediary container is filled with said milk-based substrate or with said partially fermented milk-based substrate. In a particular embodiment, at least 70% of the volume of said intermediary container is filled with said milk-based substrate or with said partially fermented milk-based substrate. In a particular embodiment, at least 80% of the volume of said intermediary container is filled with said milk-based substrate or with said partially fermented milk-based substrate. In a particular embodiment, at least 90% of the volume of said intermediary container is filled with said milk-based substrate or with said partially fermented milk-based substrate. In a particular embodiment, at least 95% of the volume of said intermediary container is filled with said milk-based substrate or with said partially fermented milk-based substrate.

Whatever the embodiment, the milk-based partially fermented substrate does not undergo any additional treatment before or during its transfer to said one or more second container. The one or more second containers is (are) filled with the milk-based partially fermented substrate using conventional filling machines (such as conventional filling machines used during set yoghurt manufacturing).

In step d) of the method of the invention, the partially fermented milk-based substrate, contained in said one or more second container(s) and whose pH is comprised between 5.4 and 6.2, is incubated until its pH reaches a range between 3.5 and 5. This incubation restarts the lactic acid fermentation—stopped by the interruption step described herein and enables to obtain a fermented set-style milk-based product. The incubation in step d) is carried out in the one or more second container(s) under appropriate conditions for the lactic acid bacteria of the starter culture to produce lactic acid and start the fermentation of the partially-fermented milk-based substrate. Incubation conditions to be used in fermentation of the partially-fermented milk-based substrate, in particular in fermentation of the partially-fermented milk substrate, are well known and the person skilled in the art will know how to select suitable incubation conditions, such as temperature, oxygen and incubation time. Obviously, incubation conditions in step d) are selected so as to obtain a fermented set-style milk-based product with a pH comprised between 3.5 and 5. In a particular embodiment, the incubation temperature is between 20 and 50° C., and in particular between 20 and 35° C. for mesophilic strains or between 35 to 50° C. for thermophilic strains. In a particular embodiment, when a lactic acid bacteria starter culture comprising or consisting of Streptococcus thermophilus and optionally Lactobacillus delbrueckii subsp. bulgaricus is used, the incubation temperature is between 30 to 50° C., more particularly between 35 and 46° C. The incubation of step d) is terminated when the desired final pH is reached, i.e., when the pH of the partially fermented milk-based substrate, in particular the partially fermented milk substrate, decreases to a value between 3.5 and 5 to obtain a fermented set-style milk-based product, in particular fermented set-style milk product. The time of incubation in step d) is typically between 1 and 3 hours.

In a particular embodiment, the invention is directed to a method to manufacture a fermented set-style milk-based product comprising:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2;
c) to transfer said partially fermented dairy substrate of step b) into one or more second container(s); and
d) to incubate said partially fermented substrate in said one or more second container(s), to restart the lactic acid fermentation until the pH reaches a range between 3.5 and 5, to obtain a fermented set-style milk-based product,
wherein the method comprises a step, after step b) and before step d), where the lactic acid fermentation of said partially fermented substrate is stopped by cooling said partially fermented dairy substrate to a temperature comprised between 2 and 10° C., more particularly between 4 and 6° C., for a period between 5 minutes and 24 hours, while maintaining the concentration of viable lactic acid bacteria stable.

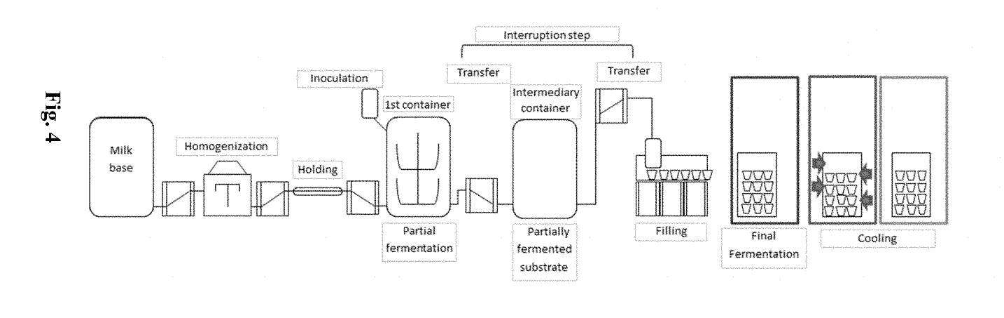

In an embodiment, the interruption step is carried out after the end of step b) and before step c) [see FIG. 3]. Thus, the invention is directed to a method to manufacture a fermented set-style milk-based product comprising or consisting:
a) to provide, in a first container, a milk-based inoculated with a lactic acid bacteria starter culture;
b) to incubate said inoculated substrate, under conditions to start the lactic acid fermentation, to obtain a partially fermented substrate with a pH comprised between 5.4 and 6.2;
b2) to stop the lactic acid fermentation of said partially fermented substrate, while maintaining the concentration of viable lactic acid bacteria stable;
c) to transfer said partially fermented dairy substrate of step b2) into one or more second container(s); and
d) to incubate said partially fermented substrate in said one or more second container(s), to restart the lactic acid fermentation until the pH reaches a range between 3.5 and 5, to obtain a fermented set-style milk-based product;
wherein the interruption step lasts for a period between 5 minutes and 24 hours.
In a particular embodiment, the lactic acid fermentation of said partially fermented substrate is stopped by cooling said partially fermented dairy substrate to a temperature comprised between 2 and 10° C., more particularly between 4 and 6° C.

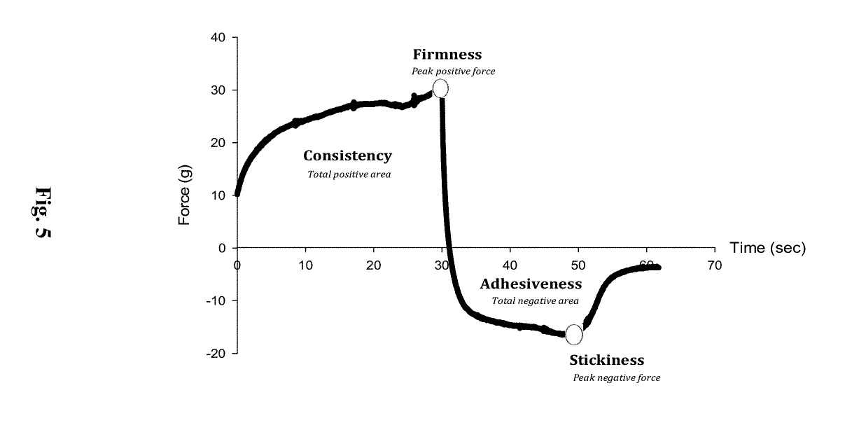

In a particular embodiment of the invention, the interruption step is carried out after the end of step b) and before step c) with an intermediary container [see FIG. 4]. Thus, the invention is also directed to a method to manufacture a fermented set-style milk-based product comprising or consisting:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2;
b2) to transfer said partially fermented substrate into an intermediary container, and to stop the lactic acid fermentation of said partially fermented substrate while maintaining the concentration of viable lactic acid bacteria stable;
c) to transfer said partially fermented dairy substrate of step b2) into one or more second container(s); and
d) to incubate said partially fermented substrate in said one or more second container(s), to restart the lactic acid fermentation until the pH reaches a range between 3.5 and 5, to obtain a fermented set-style milk-based product;
wherein the interruption step lasts for a period between 5 minutes and 24 hours.
In a particular embodiment, the lactic acid fermentation of said partially fermented substrate is stopped by cooling said partially fermented dairy substrate to a temperature comprised between 2 and 10° C., more particularly between 4 and 6° C.

In a more particular embodiment, the invention is also directed to a method to manufacture a fermented set-style milk-based product comprising or consisting:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2;
b2) to transfer said partially fermented substrate into an intermediary container while decreasing the temperature of the partially fermented substrate from the incubation temperature to a temperature comprised between 2 and 10° C., and to hold the temperature of the partially fermented substrate between 2 and 10° C.;
c) to transfer said partially fermented dairy substrate of step b2) into one or more second container(s) while increasing the temperature of the partially fermented substrate to the incubation temperature; and
d) to incubate said partially fermented substrate in said one or more second container(s), to restart the lactic acid fermentation until the pH reaches a range between 3.5 and 5, to obtain a fermented set-style milk-based product;
wherein the interruption step lasts for a period between 5 minutes and 24 hours.

In another embodiment of the invention, the interruption step is carried out after step c) and before step d). Thus, the invention is also directed to a method to manufacture a fermented set-style milk-based product comprising or consisting:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2;
c) to transfer said partially fermented substrate of step b) into one or more second container(s);
c2) to stop the lactic acid fermentation of said partially fermented substrate, for a period between 5 minutes and 24 hours, while maintaining the concentration of viable lactic acid bacteria stable;
d) to incubate said partially fermented substrate in said one or more second container(s), to restart the lactic acid fermentation until the pH reaches a range between 3.5 and 5, to obtain a fermented set-style milk-based product.

In a particular embodiment, the lactic acid fermentation of said partially fermented substrate, in said one or more second container(s), is stopped by cooling said partially fermented dairy substrate to a temperature comprised between 2 and 10° C., more particularly between 4 and 6° C.

The method to manufacture a fermented set-style milk-based product as defined herein can also comprise the following option(s):

In a particular embodiment of the method to manufacture a fermented set-style milk-based product, the method further comprises after step d):

e) to cool the fermented set-style milk-based product, in particular the set-style milk product obtained in step d)—in said one or more second container(s)—to a temperature between 15 and 22° C.

In a particular embodiment of the method to manufacture a fermented set-style milk-based product, probiotic strain(s) is (are) added into said substrate. In a particular embodiment, the probiotic strain(s) is added into the milk-based substrate of step a). The probiotic strains can be added simultaneously or subsequently to the lactic acid bacteria starter culture as defined herein. In a particular embodiment, the probiotics strain(s) and the lactic acid bacteria starter culture are added as a mixture (i.e., physically mixed together). In another embodiment, the probiotics strain(s) and the lactic acid bacteria starter culture are added as a kit-of-part (i.e., at least two separate cultures). By “probiotic strain”, it is meant any non-pathogenic bacterium or yeast which, when administered live in adequate amounts, confer a health benefit on the host. In a particular embodiment, the probiotic strain(s) is a bacterium or yeast selected from the group consisting of the genera Lactobacillus spp, Streptococcus spp, Enterococcus spp, Bifidobacterium spp and Saccharomyces spp. In a particular embodiment, the probiotic strain is a bacterium selected from the group consisting of Lactobacillus acidophilus, Lactobacillus paracasei, Bifidobacterium longum, Bifidobacterium bifidum, Bifidobacterium lactis, Bifidobacterium animalis, any mixture comprising at least one of these strains and any mixture of at least two of these strains.

An advantage of the method of the invention is that the interruption step (up to 24 hours) does not extend the total fermentation time during the whole manufacture process. Indeed, there is no lag phase (i.e., necessary time for the lactic acid bacteria to be metabolically active and to start producing lactic acid) when the incubation in step d) is continued. This advantage open flexibility for the production of fermented set-style milk-based product, such as fermented set-style milk product, in particular set-style yoghurt, while not compromising on the production time and/or on the quality of the product.

The invention also relates to a method to produce a partially fermented milk-based substrate (as an intermediary product of the method to manufacture a fermented set-style product, as defined herein).

In an embodiment, said method to produce a partially fermented milk-based substrate comprises or consists:
a) to provide a milk-based substrate inoculated with a lactic acid bacteria starter culture,
b) to incubate said inoculated substrate, under conditions to start the lactic acid fermentation, to obtain a partially fermented substrate with a pH comprised between 5.4 and 6.2; and
b2) to stop the lactic acid fermentation to keep the pH of the partially fermented substrate between 5.4 and 6.2, in particular while maintaining the concentration of viable lactic acid bacteria stable.

In a particular embodiment, said method to produce a partially fermented milk-based substrate comprises or consists:
a) to provide a milk-based substrate inoculated with a lactic acid bacteria starter culture,
b) to incubate said inoculated substrate, under conditions to start the lactic acid fermentation, to obtain a partially fermented substrate with a pH comprised between 5.4 and 6.2; and
b2) to stop the lactic acid fermentation by decreasing the temperature of the partially fermented substrate to a temperature between 2 and 10° C.
In a particular embodiment, said method to produce a partially fermented milk-based substrate comprises or consists:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2; and
b2) to stop the lactic acid fermentation by decreasing the temperature of the partially fermented substrate to a temperature between 2 and 10° C.
In a particular embodiment, step b2) comprises to hold said partially fermented substrate in the first container between 2 and 10° C.

In another particular embodiment, said method to produce a partially fermented milk-based substrate comprises or consists:
a) to provide a milk-based substrate inoculated with a lactic acid bacteria starter culture,
b) to incubate said inoculated substrate, under conditions to start the lactic acid fermentation, to obtain a partially fermented substrate with a pH comprised between 5.4 and 6.2;
b2) to transfer said partially fermented substrate of step b) into an intermediary container while decreasing the temperature of the partially fermented substrate to a temperature between 2 and 10° C., and to hold said partially fermented substrate in the intermediary container between 2 and 10° C.
In a particular embodiment, said method to produce a partially fermented milk-based substrate comprises or consists:
a) to provide in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2; and
b2) to transfer said partially fermented substrate into an intermediary container while decreasing the temperature of the partially fermented substrate to a temperature between 2 and 10° C., and to hold said partially fermented substrate in the intermediary container between 2 and 10° C.

In a particular embodiment, the method to produce a partially fermented milk-based substrate further comprises after step b2), the following step:
to store (hold) the partially fermented substrate at this temperature, in particular for a period of time between 5 minutes and 24 hours. Obviously, the partially fermented milk-based substrate obtained at the end of step b2) is stored in conditions such as maintaining the concentration of viable lactic acid bacteria of the starter culture stable during the fixed period of time. In a particular embodiment, the, optionally stored, partially fermented milk-based substrate as defined herein is suitable to be used in a method to manufacture a fermented set-style product as defined below (i.e., starting from a partially fermented milk-based substrate of the invention).

All the definitions provided herein in the context of the method to manufacture a fermented set-style product apply similarly to the method to produce a partially fermented milk-based substrate.

The invention is also directed to a partially fermented milk-based substrate with a pH comprised between 5.4 and 6.2, the temperature of which is comprised between 2 and 10° C., wherein said partially fermented milk-based substrate comprises a concentration of viable LAB of a starter culture of at least 10⁵ cfu/ml of partially fermented milk-based substrate. In a particular embodiment, said partially fermented milk-based substrate of the invention is obtained or obtainable by the method to produce a partially fermented milk-based substrate as defined herein.

The invention also relates to a container or containers (i.e., at least one container) containing a partially fermented milk-based substrate of the invention or as obtained or obtainable by the method to produce a partially fermented milk-based substrate as defined herein. In a particular embodiment, said container is a first container. In a particular embodiment, said container is a first container, whose at least 50% of the volume (such as at least 60%, 70%, 80%, 90%, 95%) contains a partially fermented milk-based substrate of the invention or as obtained or obtainable by the method to produce a partially fermented milk-based substrate as defined herein. In a particular embodiment, said container is an intermediary container. In a particular embodiment, said container is an intermediary container, whose at least 50% of the volume (such as at least 60%, 70%, 80%, 90%, 95%) contains a partially fermented milk-based substrate of the invention or as obtained or obtainable by the method to produce a partially fermented milk-based substrate as defined herein. In a particular embodiment, said container is a second container. In another embodiment, the invention also relates to at least two second containers, each containing the partially fermented milk-based substrate of the invention or as obtained or obtainable by the method to produce a partially fermented milk-based substrate as defined herein. In a particular embodiment, said at least two second containers are arranged in a row or rows of several containers (for example row(s) of 2, 4, 6 or 8 second containers) connected to one another along their flanges. Thus, in a particular embodiment, said at least two second containers are arranged as a pack comprising at least one row of separable second containers.

All the definitions provided herein in the context of the method to manufacture a fermented set-style product apply similarly to the container(s) containing a partially fermented milk-based substrate.

The invention is also directed to a method to manufacture a fermented set-style product, starting from a partially fermented milk-based substrate of the invention or as obtained or obtainable by the method to produce a partially fermented milk-based substrate as defined herein. Thus, said method to manufacture a fermented set-style product comprises or consists:
a) to provide a partially fermented milk-based substrate, in particular in a first container or in an intermediary container, or to provide one or more second container(s) containing a partially fermented milk-based substrate, wherein said partially fermented milk-based substrate is as defined in the present invention or as obtained or obtainable by the method to produce a partially fermented milk-based substrate as defined herein;
a2) if needed, to transfer the partially fermented milk-based substrate, in particular from a first container or from an intermediary container, into one or more second container(s); and
b) to incubate said partially fermented substrate in said one or more second container(s), to start the lactic acid fermentation until the pH reaches a range between 3.5 and 5, to obtain a fermented set-style milk-based product.

All the definitions provided herein in the context of the method to manufacture a fermented set-style product apply similarly.

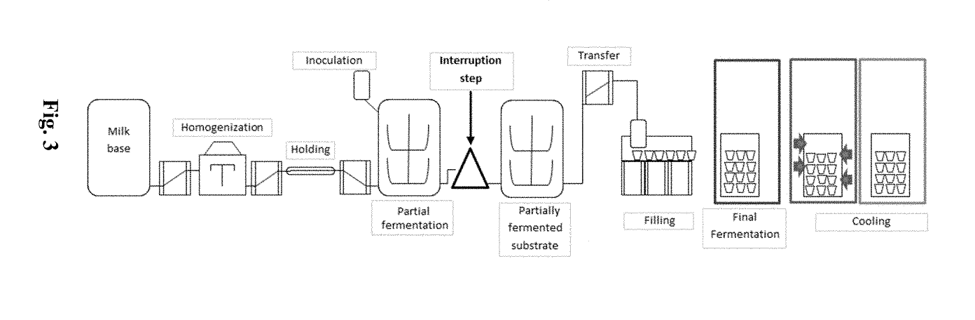

Another particular advantage of the method of the invention is the reduction of time of fermentation in the one or more second containers during the manufacture of a fermented set-style milk-based product (step d), as compared to a conventional method to manufacture a fermented set-style milk-based product (i.e., wherein the sole incubation step is carried out in said one or more second containers—FIG. 2). Therefore, the capacity of the incubation room increases, thereby increasing output per time unit and at the same time reducing energy use per kg of yoghurt. This results first from the fact that part of the incubation is carried out in a first container (until a partially fermented milk-based substrate with a pH comprised between 5.4 and 6.2 is obtained) and second the absence of a lag phase when the incubation in the one or more second containers is carried out. Thus, the invention relates to a method to reduce the time of fermentation in one or more second container(s) of at least 30% during the manufacture of a fermented set-style product, comprising or consisting:
a) to provide, in a first container, a milk-based substrate inoculated with a lactic acid bacteria starter culture;
b) to incubate said inoculated substrate, under conditions to start the lactic acid fermentation, to obtain a partially fermented substrate with a pH comprised between 5.4 and 6.2;
c) to transfer said partially fermented dairy substrate of step b) to one or more second container(s); and
d) to incubate said partially fermented substrate in said one or more second container(s), to restart the lactic acid fermentation until the pH reaches a range between 3.5 and 5, to obtain a fermented set-style milk-based product;
wherein the lactic acid fermentation of said partially fermented substrate is stopped, for a period between 5 minutes and 24 hours, after step b) and before step d), while maintaining the concentration of viable lactic acid bacteria stable; and
wherein the time of fermentation in the second container(s) is reduced of at least 30% as compared to a conventional method to manufacture a fermented set-style milk-based product.
In a particular embodiment, the lactic acid fermentation of said partially fermented substrate is stopped by cooling said partially fermented dairy substrate to a temperature comprised between 2 and 10° C., more particularly between 4 and 6° C.

The expression “time of fermentation in one or more second container(s)” means the time between the start of the incubation into the one or more second containers (which is carried out on the partially fermented substrate with an initial pH comprised between 5.4 and 6.2 within the present invention or on the milk-based substrate inoculated with a lactic acid bacteria starter culture within the conventional method to manufacture a fermented set-style milk-based product) and the manufacture of the fermented set-style milk-based product. This time corresponds industrially to the time of fermentation spent in the confined temperature-controlled room in a factory (incubation room).

According to the invention, the time of fermentation in one or more second container(s) is reduced of at least 30% as compared to a conventional method to manufacture a fermented set-style milk-based product. In a particular embodiment, said reduction is of at least 40% or of at least 50%. In a particular embodiment, said reduction is of at least 30% and at most 60%. In a particular embodiment, said reduction is of at least 30% and at most 50%. In a particular embodiment, said reduction is of at least 30% and at most 40%. The reduction of the time of fermentation in the second container(s) has also a great advantage in terms of energy savings, since the reduction of time of fermentation in the second container(s) results in less energy used per kilo of produced set-style milk-based product, in particular less energy used per kilo of produced set-yoghurt.

By “conventional method to manufacture a fermented set-style milk-based product”, it is meant a method to manufacture a fermented set-style milk-based product, in which a sole incubation step is carried out—into one or more second containers—on a milk-based substrate inoculated with a lactic acid bacteria starter culture (i.e., there is no incubation as defined herein in a first container) [FIG. 2].

It is noteworthy that in a particular embodiment, none of the methods described herein comprises an inoculation step using nisin-producing culture (or nisin-producing microorganisms) or using nisin-containing whey. Also, the partially fermented milk-based substrate of the invention (as such, in a container or used in a method) does not contain nisin or does not have any nisin activity.

All the definitions provided herein in the context of the method to manufacture a fermented set-style product apply similarly to the method to reduce the time of fermentation in one or more second container(s) during the manufacture of a fermented set-style product.

### EXPERIMENTAL

### Methods

### Measuring the Texture of Set-Style Yogurt

The impact an interruption of fermentation has on the set-style yogurt was tested employing TA-XT2i texture analyzer (Stable Micro Systems, Godalming, GB) with a 20 mm diameter probe immediately after removal from refrigerated conditions (5° C.). The set yogurt samples produced were tested after 5, 14 and 28 days of storage. The texture analyzer registers the force (g) and the distance (mm) and plots it on a curve. From the force-time curve and the resultant data output several parameters can be assessed, which are depicted on FIG. 5. The force-time curve displays the response of the sample to the application and removal of strain. The application of strain provides the positive part of the graph of which the parameters firmness and consistency can be calculated. Firmness is the highest peak and is indicative of the force needed to penetrate the yoghurt. Consistency is the area under the curve, which equals the work done on the sample and is a measure of gel rigidity. The negative part of the curve is the response of the sample when the probe is pulled back and provides the parameters adhesiveness and stickiness. Adhesiveness is the work necessary to overcome attractive forces between the surface of the food and the probe. Stickiness is the force required to separate the probe from the sample.

### Example 1 (Reproduction of Trejdo et al. 2014)

Skimmed milk (0.01% (w/w) fat; Arla, Viby, Denmark) was standardized applying skimmed milk powder and cream to obtain a protein content of 3.8% (w/w) and a fat content of 3.1% (w/w). Subsequently the milk was pasteurized and homogenized (95° C./6 min by PHE-Homo 65° C./200 bar). 4 L of standardized milk were poured into four 1 L bottles and inoculated with 1.10⁶ to 1.10⁷ cfu/ml of the yogurt culture YO-Mix® 810 FRO [YO-Mix® 810 is a blend of Streptococcus thermophilus and Lactobacillus delbrueckii subsp. bulgaricus strains, provided as frozen concentrated pellets; Danisco DuPont reference 1271155]. The inoculated milk is then fermented at 43° C. (incubation). The fermentation was interrupted at pH 5.2 applying a yogurt cooler, which cools down the milk to 4° C. The cooled milk was poured into glass beakers (100 ml each) and stored for 20 h at 4° C. until further fermentation to a pH of 4.6 at 43° C. (incubation). 1 L of milk was used as a control and directly fermented at 43° C. in glass beakers to a pH 4.6.

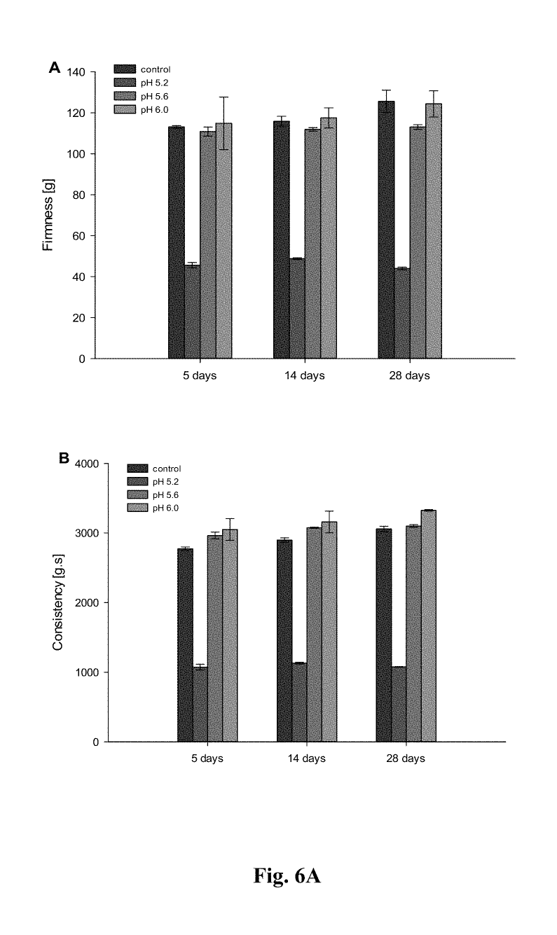

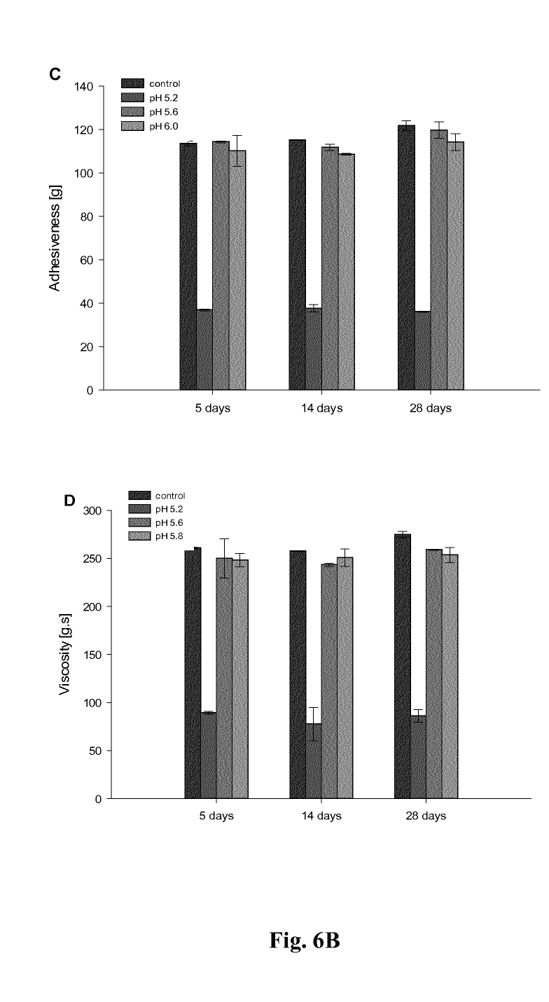

Texture properties (firmness, consistency, adhesiveness, and viscosity) were calculated as described under methods above. The effects of the interruption of the fermentation at pH 5.2 on the textural properties are shown in FIGS. 6A to 6D (compared with control).

This example revealed that an interruption at pH 5.2, as taught in Trejdo et al. 2014, had a negative impact on all quality characteristics tested, which are important factors for the overall acceptably by the consumer. Interruption at pH 5.2 resulted in severely deteriorated textural properties, when compared to the control (no interruption). Moreover, a strong syneresis was visible after termination of the fermentation at a pH of 4.6.

### Example 2 (Interruption at pH 5.6 and 6.0)

Despite these unsuccessful results, the inventors carried out the same experiments as in example 1, except that the fermentation was interrupted at pH 5.6 and 6.0, instead of 5.2. Texture properties (firmness, consistency, adhesiveness and viscosity) were calculated as described under methods above. The effects of the interruption of the fermentation at either pH 5.6 or 6.0 on the textural properties are shown in FIGS. 6A to 6D.

In contrast to the results obtained with an interruption at pH 5.2, an interruption at pH 5.6 or at pH 6.0 showed unchanged textural properties or even a slight improvement of the textural properties as compared to a control (no interruption). Comparable results were achieved in preliminary trials conducted in laboratory scale (data not shown).

### CONCLUSION

Contrary to the results of Trejo et al. (2014) who showed that the introduction of a cold step at pH 5.2 resulted in yogurt gels showing a stronger structure and improved rheological properties, example 1 showed that all tested properties deteriorated as compared to a non-interrupted control. Apparently, the disturbance of the already started gel network formation did not result in a rearrangement of casein micelles after the temperature was increased again. However, the introduction of the cold step at higher pH values did not have a significant impact on the texture of the yogurt samples tested after fermentation.

### Example 3: Impact of the Interruption Step on the Total Fermentation Time

Further experiments were carried out by interrupting the fermentation at a pH of 5.8, since example 2 showed promising results, in terms of textural properties, with an interruption at pH values of 5.6 or 6.0. In this example, the trials focused on the influence of the interruption step on fermentation conducted with 5 different LAB starter cultures on various milk substrates.

### 3.1. Milk Substrate Preparation

Two milk substrates were prepared:

Milk substrate A: Skimmed milk (0.01% (w/w) fat; Arla, Viby, Denmark) was standardized applying skimmed milk powder and cream to obtain a protein content of 3.8% (w/w) and a fat content of 3.1% (w/w). Subsequently, the milk was pasteurized and homogenized (95° C. for 6 min by PHE-Homo 65° C./200 bar).

Milk substrates B: the powder ingredients of Table 1 (in grams) were mixed and dry blended with the milk/cream suspension under agitation at 45° C. The mixture was mixed for 30 minutes and filled into buckets. Then, the pasteurization of the mixture was performed as follows: preheating to 70° C. (P1), homogenization at 70° C./200 bars, pasteurization at 95° C. for 6 minutes, cooling to 5° C., and storage in cold room overnight.

TABLE 1
Ingredients used for preparation of milk substrate

| | Milk substrate B | | |
|---|---|---|---|
| | B1 | B2 | B3 |
| Skimmed milk - Milkoscan | 9232 | 9514 | 8615 |
| prot % = 3.57 - fat % = 0.04 | | | |
| Cream 38% fat - Milkoscan | 395.42 | 396.21 | 831.24 |
| prot % = 2.04 - fat % = 36.79 | | | |
| Skimmed milk powder DMK | 173.05 | 89.50 | 153.98 |
| Sucrose | 200.00 | — | 400.00 |
| Total | 10000 | 10000 | 10000 |

### 3.2 Starter Cultures

The following starter cultures were tested:
YO-Mix® 560 FRO: a blend of Streptococcus thermophilus and Lactobacillus delbrueckii subsp. bulgaricus strains, provided as frozen concentrated pellets (Danisco DuPont reference 1271155);
YO-Mix® 570 FRO: a blend of Streptococcus thermophilus and Lactobacillus delbrueckii subsp. bulgaricus strains, provided as frozen concentrated pellets (Danisco DuPont reference 90735);
YO-Mix® 211 LYO: a blend of Streptococcus thermophilus, Lactobacillus delbrueckii subsp. bulgaricus, Lactobacillus acidophilus and Bifidobacterium lactis strains, provided as freeze-dried powder (Danisco DuPont reference 90655);
CHOOZIT™ MS512 FRO is a blend of Lactococcus lactis subsp. lactis and Leuconostoc mesenteroides subsp cremoris strains, provided as frozen concentrated pellets (Danisco DuPont reference 31642); and
BS V8-2: bulk starter of a blend of Streptococcus thermophilus and Lactobacillus delbrueckii subsp. bulgaricus strains.

### 3.3. Fermentation Conditions

For each starter culture, two times 3 L of milk substrate (A, B1, B2 or B3), which were filled in vats, were inoculated with 1.10⁶ to 1.10⁷ cfu/ml of the starter culture (according to Table 2). The fermentation of the samples inoculated by each starter culture was carried out at 30 or 43° C. (incubation see Table 2) and was stopped at a pH of 5.8 applying a yogurt cooler.

TABLE 2
Fermentation conditions for each tested starter culture

| | | Fermentation |
|---|---|---|
| Starter culture | Milk substrate | temperature [° C.] |
| YO-Mix ® 560 | A | 43 |
| YO-Mix ® 570 | A | 43 |
| YO-Mix ® 211 | B1 | 43 |
| CHOOZIT ™ MS512 | B2 | 30 |
| BS V8-2 | B3 | 43 |

The samples were stored at 5° C. for 19-20 h, and poured in glass beakers the next morning, heated to 30 or 43° C. again (incubation) and were subsequently fermented to a final pH of 4.6. In parallel, control samples of each starter culture were directly fermented (30 or 43° C.) to the final pH of 4.6, filled into glass beakers and stored at 5° C. (without interruption)

First, for each sample, the total fermentation time to reach pH 4.6 was measured. For the control, the total fermentation time to reach pH 4.6 was measured. For the test samples (interruption step), the fermentation time to reach 5.8 and the fermentation time from pH 5.8 to pH 4.6 were measured (Table 3).

TABLE 3
Fermentation time needed (in minutes) to reach the different pH values
for both the interrupted fermentation samples and the controls
(uninterrupted fermentation), fermented with each tested
culture (n.a.: not applicable); *time corresponding to the fermentation
in the food packages (industrially in the incubation room)

| | | Time from | Total |
|---|---|---|---|
| | Time to pH 5.8 | pH 5.8 | time to pH 4.6 |
| | [min] | to 4.6 [min] | [min] |
| YO-Mix ® 560 control | n.a. | n.a. | 230 ± 0* |
| YO-Mix ® 560 | 150 ± 0 | 100 ± 0* | 250 ± 0 |
| interrupted | | | |
| YO-Mix ® 570 control | n.a. | n.a. | 230 ± 0* |
| YO-Mix ® 570 | 140 ± 0 | 120 ± 0* | 260 ± 0 |
| interrupted | | | |
| YO-Mix ® 211 control | n.a. | n.a. | 315 ± 0* |
| YO-Mix ® 211 | 155 ± 0 | 150 ± 25* | 305 ± 25 |
| interrupted | | | |
| CHOOZIT ™ MS512 | n.a. | n.a. | 425 ± 0* |
| control | | | |
| CHOOZIT ™ MS512 | 245 ± 0 | 215 ± 15* | 455 ± 15 |
| interrupted | | | |
| BS V8-2 control | n.a. | n.a. | 230 ± 10* |
| BS V8-2 interrupted | 100 ± 0 | 125 ± 0* | 225 ± 0 |

When comparing the total fermentation times, the comparison of the total time of fermentation show that the fermentation by YO-Mix® 211 or by the bulk starter BS V8-2 slightly decreased, whereas the fermentation by YO-Mix® 560, YO-Mix® 570 and CHOOZIT™ MS512 needed a longer time to reach pH 4.6. However, neither the decrease nor the increase was significant.

More striking is the fact that the introduced interruption step did not lead to an additional lag-phase, despite the 19-20 h interruption of the fermentation (the lag phase typically corresponds to the time needed by the bacteria of the starter culture to be metabolically active in the substrate after inoculation or in the present case after the interruption step; a short lag phase or an absence of lag phase means that the bacteria are metabolically active as soon as they are at the fermentation temperature). The minor difference in the overall fermentation time between the interrupted fermentation and the non-interrupted fermentation (control) is most likely a result of the up-heating of the partially fermented milk-based substrate from 4° C. to 43° C. (which can't be done instantly in a pilot plant scale).

As shown in Table 3, the fermentation time in food packages (time spent in the incubation room in the factory) is reduced by from 45.6% (BS V8-2) to 56.6% (YO-Mix® 560) as compared to a conventional (non-interrupted) process carried out with the same starter culture (* in Table 3).

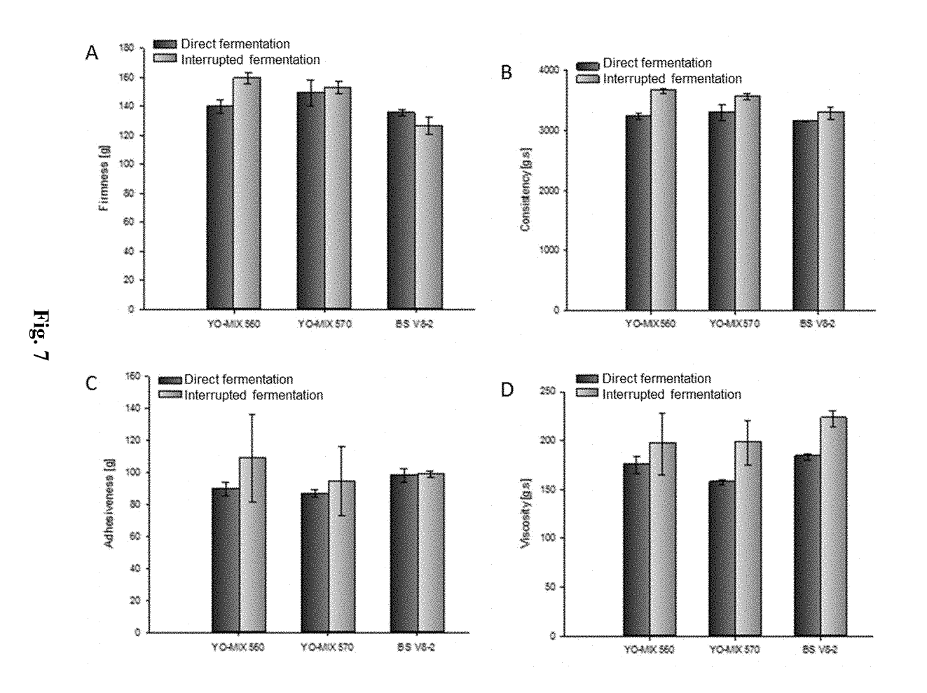

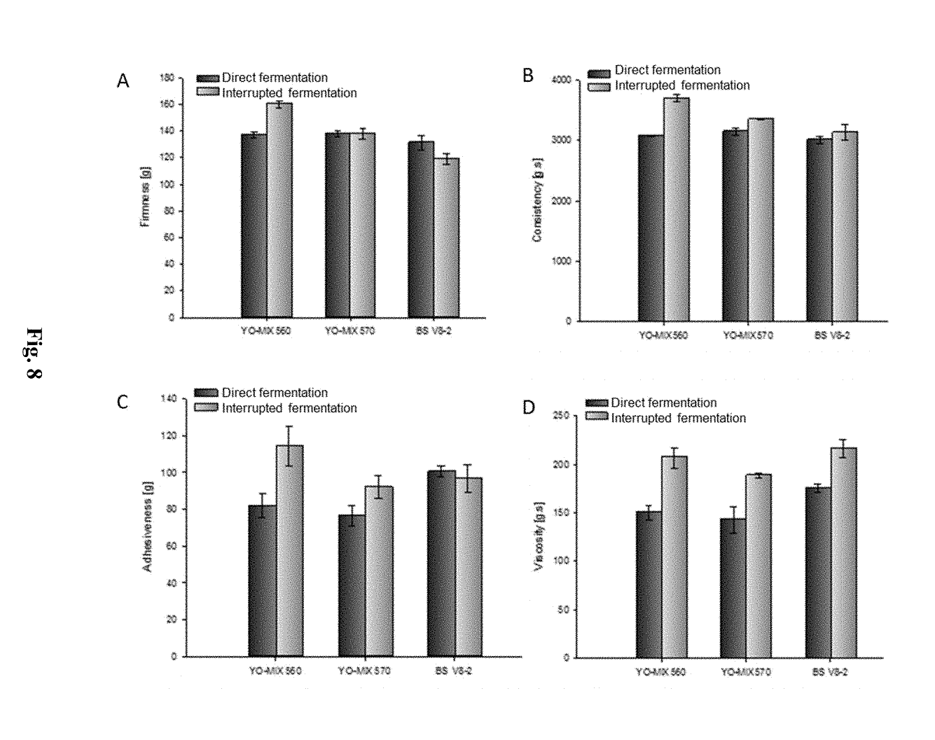

Then, texture properties (firmness, consistency, adhesiveness and viscosity) of the interrupted and control samples for 3 starter cultures were calculated as described under methods above. The effects of the interruption of the fermentation at pH 5.8—using different cultures—on the texture properties are shown in FIG. 7 (14 days) and FIG. 8 (28 days).

As shown in FIGS. 7 and 8, the interruption step had a throughout rather positive effect on the rheological properties of the fermented set milk product after 14 or 28 days of storage, whatever the tested cultures used for fermentation.

Altogether these data show that the inventors did successfully design a process to manufacture fermented set milk products, which combines a reduction of the time spent in the food packages (so in the incubation room). The inventors also showed that this process enables to maintain the quality (rheological properties) of the fermented set milk products. This new process will answer the technical problem of substantially increasing the capacity production of fermented set milk products during demand peaks.

### Example 4: Application to a Mixture of Milk and Soy Protein Concentrate

Substrate C was prepared as follow. The powder ingredients of Table 4 (in grams) were mixed and dry blended with the milk/cream suspension under agitation at 45° C. The mixture was mixed for 30 minutes and filled into buckets. Then, the pasteurization of the mixture was performed as follows: preheating to 70° C. (P1), homogenization at 70° C./200 bars, pasteurization at 95° C. for 6 minutes, cooling to 5° C., and storage in cold room overnight.

TABLE 4
Ingredients used for milk-based substrate C

| | Milk-based |
|---|---|
| | substrate |
| | C |
| Skimmed milk - Milkoscan prot % = 3.57 - fat % = 0.04 | 8962 |
| Cream 38% fat - Milkoscan prot % = 2.04 - fat % = 36.79 | 825.95 |
| ALPHA ® 5812 IP Soy protein concentrate | 212.47 |
| Total | 10000 |

Two times 3 L of milk-based substrate C, which were filled in vats, were inoculated with 1.10⁶ to 1.10⁷ cfu/ml of the yogurt culture YO-Mix® 860 FRO [YO-Mix® 860 is a blend of Streptococcus thermophilus and Lactobacillus delbrueckii subsp. bulgaricus strains, provided as frozen concentrated pellets; Danisco reference 83859]. The fermentation was carried out at 43° C. and was stopped at a pH of 5.8 applying a yogurt cooler. These samples were stored at 5° C. for 19-20 h, poured in glass beakers the next morning, heated to 43° C. again (incubation) and were subsequently fermented to a final pH of 4.6. In parallel, control samples of each starter culture were directly fermented to the final pH of 4.6, filled into glass beakers and stored at 5° C. (without interruption).

For the test samples (interruption step), the fermentation time to reach 5.8 and the fermentation time from pH 5.8 to pH 4.6 were measured. For the control, the total fermentation time to reach pH 4.6 was measured (Table 5).

TABLE 5
Comparison of an interrupted fermentation to a non-interrupted yogurt
fermentation employing a milk-soy mixture

| | Time from pH | Time from pH | Overall fermentation |
|---|---|---|---|
| Culture | 6.7 to 5.8 [min] | 5.8 to 4.6 [min] | time [min] |
| YO-MIX ® 860 | n.a. | n.a. | 280 ± 0* |
| (control) | | | |
| YO-MIX ® 860 | 125 ± 0 | 125 ± 0* | 250 ± 0 |

As shown in Table 5, the fermentation time in food packages (time spent in the incubation room in the factory) is reduced by from 55.3% as compared to a conventional (non-interrupted) process carried out with the same starter culture (* in Table 5).

These data confirm that the same benefits in terms of time of fermentation, in particular in food packages, can be obtained for milk-based substrate (such as soy and milk mixture) as for milk substrate.

1. A method to manufacture a fermented set-style milk-based product comprising:
a) providing, in a first container, a milk-based substrate inoculated with a lactic acid bacteria starter culture;
b) incubating said inoculated substrate, under conditions to start the lactic acid fermentation, to obtain a partially fermented substrate with a pH comprised between 5.4 and 6.2;
c) transferring said partially fermented dairy substrate of step b) into one or more second container(s); and
d) incubating said partially fermented substrate in said one or more second container(s), to restart the lactic acid fermentation until the pH reaches a range between 3.5 and 5, to obtain a fermented set-style milk-based product,
wherein the method further comprises a step, after step b) and before step d), where the lactic acid fermentation of said partially fermented substrate is stopped by cooling said partially fermented dairy substrate to a temperature comprised between 2 and 10° C. for a period between 5 minutes and 24 hours, while maintaining the concentration of viable lactic acid bacteria stable.

2. The method according to claim 1, comprising:
a) providing, in a first container, a milk-based substrate inoculated with a lactic acid bacteria starter culture;
b) incubating said inoculated substrate, under conditions to start the lactic acid fermentation, to obtain a partially fermented substrate with a pH comprised between 5.4 and 6.2;
b2) stopping the lactic acid fermentation of said partially fermented substrate for a period between 5 minutes and 24 hours, while maintaining the concentration of viable lactic acid bacteria stable;
c) transferring said partially fermented dairy substrate of step b2) into one or more second container(s); and
d) incubating said partially fermented substrate in said one or more second container(s), to restart the lactic acid fermentation until the pH reaches a range between 3.5 and 5, to obtain a fermented set-style milk-based product.

3. A method to manufacture a fermented set-style milk-based product, comprising:
a) providing, in a first container, a milk-based substrate inoculated with a lactic acid bacteria starter culture;
b) incubating said inoculated substrate, under conditions to start the lactic acid fermentation, to obtain a partially fermented substrate with a pH comprised between 5.4 and 6.2;
b2) transferring said partially fermented substrate of step b) into an intermediary container, and stopping the lactic acid fermentation of said partially fermented substrate for a period between 5 minutes and 24 hours while maintaining the concentration of viable lactic acid bacteria stable;
c) transferring said partially fermented dairy substrate of step b2) into one or more second container(s); and
d) incubating said partially fermented substrate in said one or more second container(s), to restart the lactic acid fermentation until the pH reaches a range between 3.5 and 5, to obtain a fermented set-style milk-based product.

4. The method according claim 3, wherein the lactic acid fermentation is stopped by cooling said partially fermented dairy substrate to a temperature comprised between 2 and 10° C.

5. The method according to claim 1, wherein said fermented set-style milk-based product is set-yoghurt.

6. A method to produce a partially fermented milk-based substrate, comprising
a) providing, in a first container, a milk-based substrate inoculated with a lactic acid bacteria starter culture;
b) incubating said inoculated substrate, under conditions to start the lactic acid fermentation, to obtain a partially fermented substrate with a pH comprised between 5.4 and 6.2; and
b2) stopping the lactic acid fermentation to keep the pH of the partially fermented substrate between 5.4 and 6.2, by decreasing the temperature of the partially fermented dairy substrate to a temperature comprised between 2 and 10° C.

7. A method to produce a partially fermented milk-based substrate according to claim 6, comprising
a) providing in a first container, a milk-based substrate inoculated with a lactic acid bacteria starter culture;
b) incubating said inoculated substrate, under conditions to start the lactic acid fermentation, to obtain a partially fermented substrate with a pH comprised between 5.4 and 6.2; and
b2) either:
stopping the lactic acid fermentation by decreasing the temperature of the partially fermented substrate to a temperature between 2 and 10° C., to obtain a partially fermented milk-based substrate, and holding said partially fermented substrate in the first container between 2 and 10° C.; or
transferring said partially fermented substrate into an intermediary container while decreasing the temperature of the partially fermented substrate to a temperature between 2 and 10° C., and holding said partially fermented substrate in the intermediary container between 2 and 10° C.

8. The method according to claim 1, wherein said incubation in step b) and/or in step d) is (are) done at a temperature comprised between 20 and 50° C.

9. The method according to claim 1, wherein said milk-based substrate of step a) is inoculated with a lactic acid bacteria starter culture at a concentration of at least 10⁵ cfu/g of substrate.

10. The method according to claim 1, wherein said lactic acid bacteria starter culture comprises a Streptococcus thermophilus strain.

11. The method according to claim 1, wherein said milk-based substrate of step a) is a milk substrate.

12. The method according to claim 1, wherein said one or more second container(s) is(are) a food container.

13. A first container containing a partially fermented milk-based substrate with a pH comprised between 5.4 and 6.2, the temperature of which is comprised between 2 and 10° C., wherein said partially fermented milk-based substrate comprises a concentration of viable lactic acid bacteria of at least 10⁵ cfu/ml of partially fermented milk-based substrate, obtained by the method to produce a partially fermented milk-based substrate of claim 6.

14. An intermediary container containing a partially fermented milk-based substrate with a pH comprised between 5.4 and 6.2, the temperature of which is comprised between 2 and 10° C., wherein said partially fermented milk-based substrate comprises a concentration of viable lactic acid bacteria of at least 10⁵ cfu/ml of partially fermented milk-based substrate, obtained by the method to produce a partially fermented milk-based substrate of claim 6.

15. A method to manufacture a fermented set-style product comprising:
a) providing either a partially fermented milk-based substrate with a pH comprised between 5.4 and 6.2, the temperature of which is comprised between 2 and 10° C., wherein said partially fermented milk-based substrate comprises a concentration of viable lactic acid bacteria of at least 10⁵ cfu/ml of partially fermented milk-based substrate, obtained by the method to produce a partially fermented milk-based substrate of claim 6; and
b) incubating said partially fermented substrate, to start the lactic acid fermentation until the pH reaches a range between 3.5 and 5, to obtain a fermented set-style milk-based product.

16. A method to reduce the time of fermentation in one or more second container(s) of at least 30% during the manufacture of a fermented set-style product, comprising:
a) providing, in a first container, a milk-based inoculated with a lactic acid bacteria starter culture;
b) incubating said inoculated substrate, under conditions to start the lactic acid fermentation, to obtain a partially fermented substrate with a pH comprised between 5.4 and 6.2;
c) transferring said partially fermented dairy substrate of step b) to one or more second container(s);
d) incubating said partially fermented substrate in said one or more second container(s), to restart the lactic acid fermentation until the pH reaches a range between 3.5 and 5, to obtain a fermented set-style milk-based product,
wherein the lactic acid fermentation of said partially fermented substrate is stopped by cooling said partially fermented dairy substrate to a temperature comprised between 2 and 10° C. for a period between 5 minutes and 24 hours, after step b) and before step d), while maintaining the concentration of viable lactic acid bacteria stable; and
wherein the time of fermentation in the second container(s) is reduced at least 30% as compared to a method to manufacture a fermented set-style milk-based product in which the incubation step of the inoculated substrate is carried out in one or more second container(s) only.

17. The method according to claim 1, wherein the lactic acid fermentation of said partially fermented substrate is stopped by cooling said partially fermented dairy substrate to a temperature comprised between 4 and 6° C. for a period between 5 minutes and 24 hours, while maintaining the concentration of viable lactic acid bacteria stable.

18. The method according to claim 4, wherein the lactic acid fermentation is stopped by cooling said partially fermented dairy substrate to a temperature comprised between 4 and 6° C.

19. The method according to claim 6, wherein the process comprises stopping the lactic acid fermentation to keep the pH of the partially fermented substrate between 5.4 and 6.2 by decreasing the temperature of the partially fermented dairy substrate to a temperature comprised between 4 and 6° C.

20. The method according to claim 8, wherein the incubation in step b) and/or in step d) is (are) done at a temperature comprised between 35 and 46° C.

21. The method according to claim 10, wherein said lactic acid bacteria starter culture further comprises a Lactobacillus strain.

22. The method according to claim 10, wherein said lactic acid bacteria starter culture further comprises a Lactobacillus delbrueckii subp bulgaricus strain.
